(19) United States
(12) Patent Application Publication
(10) Pub. No.: US 2009/0223475 A1
(43) Pub. Date: Sep. 10, 2009

(54) Implement With Two Hand Interlock

(76) Inventors: Grant Thomas Wilson, Neenah, WI (US); Brian J. Witt, Brillion, WI (US)

Correspondence Address: QUARLES & BRADY LLP, 411 E. WISCONSIN AVENUE, SUITE 2040, MILWAUKEE, WI, 53202-4497, US

(21) Appl. No.: 12/045,499

(22) Filed: Mar. 10, 2008

(51) Int. Cl. F02N 11/10

(52) U.S. Cl. 123/179.4

(57) ABSTRACT

An implement includes an electric starter operatively connected to an internal combustion engine to start the internal combustion engine. An ignition circuit actuates the electric starter. A first normally open switch forming part of the ignition circuit is mounted on the implement at a first position and must be held closed by an operator for the ignition circuit to actuate the electric starter. A second normally open switch forming part of the ignition circuit is mounted on the implement at a second position and must be held closed by an operator for the ignition circuit to actuate the electric starter. The first position is spaced from the second position a sufficient distance to prevent an operator from closing both the first normally open switch and the second normally open switch with a single hand.

### CROSS REFERENCES TO RELATED APPLICATIONS

Not Applicable.

### STATEMENT REGARDING FEDERALLY SPONSORED RESEARCH

Not Applicable

### TECHNICAL FIELD

The present invention relates to the implements, and more particularly to an implement including an engine start interlock.

### DESCRIPTION OF THE BACKGROUND ART

Implements, such as lawn mowers and snow blowers, are typically powered by a prime mover, such as an internal combustion engine. Many of these implements have an electric start, i.e. the engine is started by an electric starter connected to a battery or other electrical source. Current manufacturers include sensors in an ignition circuit actuating the starter to ensure certain conditions are met prior to starting the engine. For example, sensor switches incorporated in the ignition circuit are often used to determine the position of the controls for the power take off (PTO), ground drive, and parking brake.

The sensors are provided to ensure the PTO is disengaged and the parking brake is engaged when starting the engine. The goal of these and other sensors is to ensure the implement does not surprise the operator with any unexpected actions when the engine is started. Unfortunately, providing multiple sensors that determine the position of various implement controls complicates the ignition circuit rendering the implement unreliable. Therefore a need exists for a simpler and more reliable implement that will not surprise an operator with any unexpected actions.

### SUMMARY OF THE INVENTION

The present invention provides a simpler and more reliable implement that will not surprise an operator with any unexpected actions by providing an implement that ensures an operator is not inadvertently operating controls while starting the engine. This is accomplished by requiring the operator use two hands to start the engine making it very difficult to engage the PTO or ground drive.

One embodiment of the present invention is an implement including an internal combustion engine. An electric starter is provided to start the internal combustion engine. An ignition circuit actuates the electric starter. A first normally open switch forming part of the ignition circuit is mounted on the implement at a first position and must be held closed by an operator for the ignition circuit to actuate the electric starter. A second normally open switch forming part of the ignition circuit is mounted on the implement at a second position and must be held closed by an operator for the ignition circuit to actuate the electric starter. The first position is spaced from the second position a sufficient distance to prevent an operator from closing both the first normally open switch and the second normally open switch with a single hand.

The advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF DESCRIPTION OF THE DRAWINGS

FIG. 1 is a front right perspective view of an implement incorporating the present invention;

FIG. 2 is a top view of the implement of FIG. 1; and

FIG. 3 is a schematic drawing of an ignition circuit for the implement of FIG. 1.

### DETAILED DESCRIPTION OF THE PREFERRED EMBODIMENTS

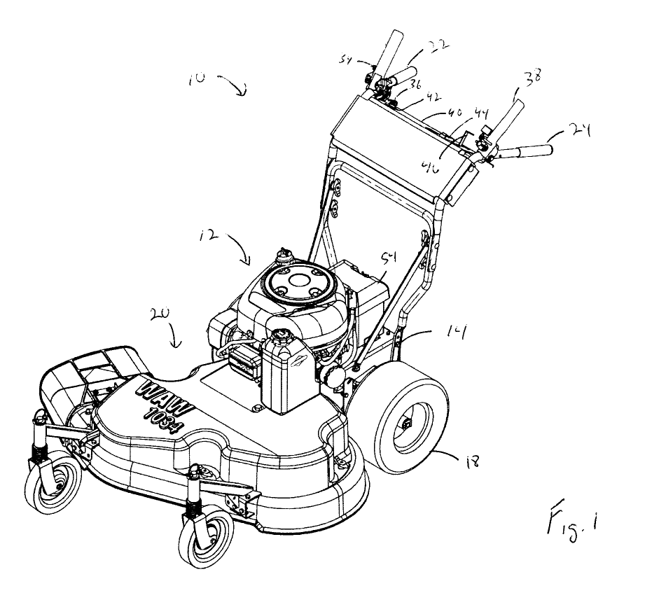

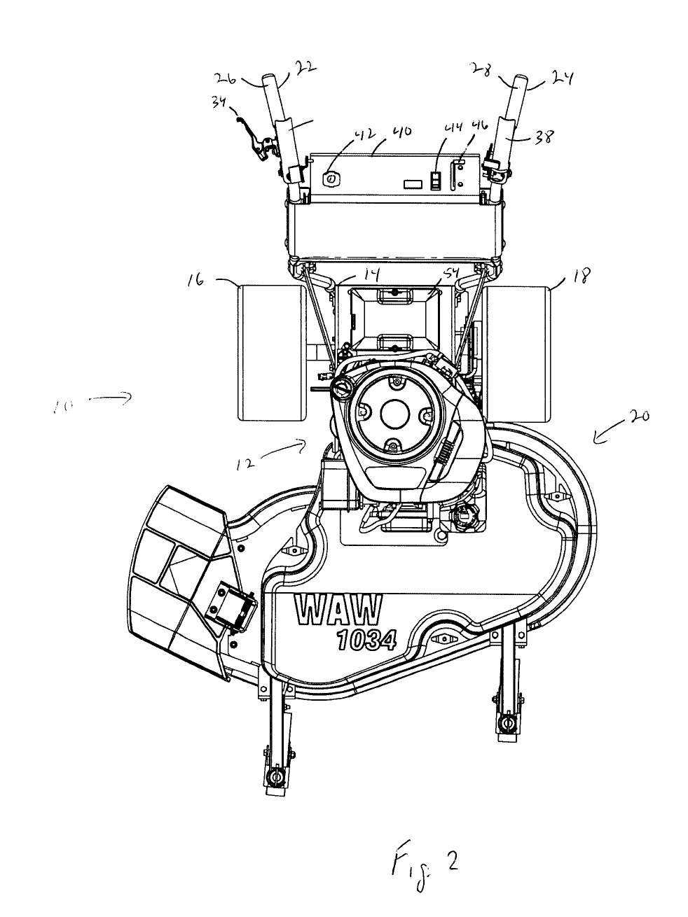

As shown in FIGS. 1 and 2, an implement 10 is powered by an internal combustion engine 12 mounted on a frame 14. The frame 14 is supported by a pair of ground engaging drive wheels 16, 18 operatively connected to the engine 12 by a transmission. The engine 12 also drives the blades of a lawn mower deck 20 supported by the frame 14. Although a mower deck 20 is shown, other working devices can be supported by the frame 14, such as a snow blowing blower, tiller, and the like, without departing from the scope of the invention.

Right and left handlebars 22, 24 extending rearwardly from the frame 14 include grips 26, 28 for grasping by the operator to steer the implement 10. Forward and reverse control levers 34, 36 pivotally mounted proximal the grip 26 on the right handlebar 22 selectively engage the engine 12 to propel the implement 10 in the forward and reverse directions. A PTO lever 38 pivotally mounted on the left handlebar 24 selectively engages the blades in the mower deck 20 with the engine 12 to rotate the blades for cutting grass.

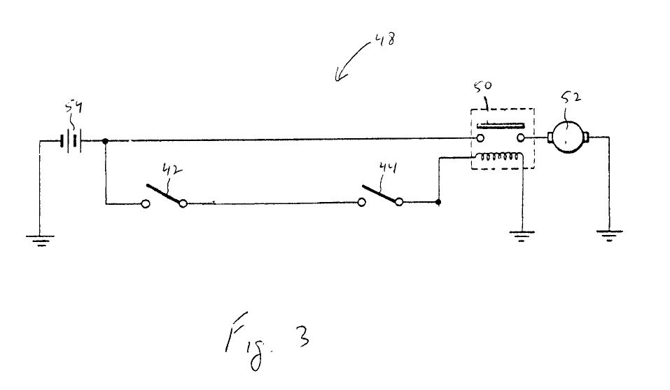

A control panel 40 extending between the handlebars 22, 24 supports a key switch 42, an interlock switch 44, and a throttle control 46. The key switch 42 and interlock switch 44 form part of an ignition circuit 48, such as shown in FIG. 3. The throttle control controls the flow of fuel to the engine 12. The control panel 40 is fixed to and supported by the handlebars 22, 24. Of course, the control panel 40 can be fixed to any part of the implement 10 at any location without departing from the scope of the invention.

The ignition circuit 48 includes the key switch 42, interlock switch 44, a starter solenoid 50, and a battery 54 (also shown in FIGS. 1 and 2). Of course, other interlocks or contacts may be in the ignition circuit 48, such as interlock switches requiring the PTO is disengaged, the drive transmission(s) is disengaged, and the like, without departing from the scope of the invention. Actuation of the starter solenoid 50 engages an electric starter 52 with the engine 12 and energizes the electric starter 52 to turn, and thus start, the engine 12. Importantly, actuation of the starter solenoid 50, and thus the electric starter 52, requires that both the key switch 42 and interlock switch 44 are closed.

The interlock switch 44 is preferably a normally open momentary rocker switch having an open position and a closed position. The interlock switch 44 is biased away from the closed position and must be held in the closed position by the operator to maintain the switch 44 in the closed position when starting the engine 12. Although a momentary rocker switch is disclosed, any normally open switch biased away from a closed position, such as a keyed switch, push button switch, and the like can be used without departing from the scope of the invention.

The key switch 42 is a normally open standard keyed ignition switch and requires turning a key inserted in a key hole to close the key switch 42. Preferably, the key switch 42 is biased away from the closed position requiring the operator hold the key in a turned position to keep the switch 42 closed when starting the engine 12. Although a key switch 42 is disclosed, any normally open switch biased away from a closed position, such as a momentary rocker switch, push button switch, and the like, can be used without departing from the scope of the invention.

Advantageously, the key switch 42 and interlock switch 44 are mounted on the control panel 40 at positions a sufficient distance from each other to prevent the operator from actuating, i.e. closing, both switches 42, 44 using one hand. As a result, two hands are required to start the engine 12. In particular, one hand must turn the key in the key switch 42 and the other hand must depress the interlock switch 44 to start the engine 12. As a result, the location of both hands of the operator are known at the time the engine 12 is started. Advantageously, by requiring an operator to use both hands to start the engine 12, it is very difficult for the operator to inadvertently have the PTO or ground drive engaged when starting the engine 12.

The location and type of the switches determines whether a distance is sufficient to prevent an operator from closing two normally open, operator actuated switches. For example, between three and five inches is sufficient to prevent an operator from actuating both a key ignition switch and a rocker switch mounted on the face of a control panel. Eight inches, however, are required if both switches are rocker switches. Whereas, two inches is sufficient if both switches are key ignition switches. Likewise, overlapping edges of the switches separated by the thickness of the control panel is sufficient for two rocker switches if one rocker switch is mounted to the face of the control panel and the other rocker switch is mounted on the back of the control panel.

Preferably, as shown in FIG. 2, the key switch 42 is proximal the right handlebar 22 and the interlock switch 44 is proximal the left handlebar 24. Most preferably, the centerline of the key switch 42 is spaced nine and one-third (9⅓) inches from an edge of the interlock switch 44. In the embodiment disclosed herein, an edge of the key switch 42 closest to the interlock switch 44 is spaced eight and one-half (8½) inches from an edge of the interlock switch 44 closet to the key switch 42. However, a key switch 42 spaced at least five (5) inches away from the interlock switch 44 is also a sufficient distance to prevent an operator from closing both the key switch 42 and the interlock switch 44 with a single hand. Of course, the key switch 42 and interlock switch 44 can be mounted anywhere on the implement 10 as long as the switches 42, 44 are spaced a sufficient distance to prevent an operator from closing both the key switch 42 and the interlock switch 44 with a single hand without departing from the scope of the invention.

In use, the operator starts the engine 12 by inserting a key into the key switch 42 with a right hand and depressing the interlock switch 44 with a left to close the interlock switch 44. While depressing the interlock switch 44 with the left hand, the operator turns the key in the key switch 42 to close the key switch 42. Assuming all other contacts, if present, in the ignition circuit 48 are properly closed, the ignition circuit 48 energizes the starter solenoid 50 to actuate the electric starter 52 and start the engine 12. Of course, the locations of the key switch 42 and interlock switch 44 can be different from that shown in the FIGS. 1 and 2, such that the operator closes the key switch 42 using the left hand and the right hand closes the interlock switch 44 without departing from the scope of the invention.

While there has been shown and described what is at present considered the preferred embodiment of the invention, it will be obvious to those skilled in the art that various changes and modifications can be made therein without departing from the scope of the invention defined by the appended claims.

We claim:

1. An implement comprising:
an internal combustion engine;
an electric starter operatively connected to said internal combustion engine to start said internal combustion engine;
an ignition circuit operatively connected to said electric starter for actuating said electric starter;
a first normally open operator actuated switch forming part of said ignition circuit, said first normally open switch being mounted on said implement at a first position and which must be held closed by an operator for said ignition circuit to actuate said electric starter; and
a second normally open operator actuated switch forming part of said ignition circuit, said second normally open switch being mounted on said implement at a second position and which must be held closed by an operator for said ignition circuit to actuate said electric starter, said first position being spaced from said second position a sufficient distance to prevent an operator from closing both said first normally open switch and said second normally open switch with a single hand.

2. The implement as in claim 1, in which said engine is mounted on a frame having a first rearwardly extending handlebar and a second rearwardly extending handlebar for grasping by a user, and said first normally open switch is mounted proximal said first rearwardly extending handlebar and said second normally open switch is mounted proximal said second rearwardly extending handlebar.

3. The implement as in claim 2, including a panel extending between said first rearwardly extending handlebar and said second rearwardly extending handlebar, and said first normally open switch and said second normally open switch are fixed to said panel.

4. The implement as in claim 1 including a working device operatively connected to said internal combustion engine.

5. The implement as in claim 4, in which said working device is a mower deck.

6. The implement as in claim 1, in which said first normally open switch and said second normally open switch are spaced at least five (5) inches apart.

7. The implement as in claim 6, in which said first normally open switch and said second normally open switch are spaced at least eight (8) inches apart.

8. The implement as in claim 1, in which at least one of said first normally open switch and said second normally open switch is a keyed ignition switch.

9. The implement as in claim 1, in which at least one of said first normally open switch and said second normally open switch is a momentary rocker switch.

10. A method of starting an implement including an internal combustion engine, an electric starter operatively connected to said internal combustion engine to start said internal combustion engine, and an ignition circuit operatively connected to said electric starter for actuating said electric starter to start the engine, said method comprising:
closing a first normally open switch forming part of said ignition circuit, said first normally open switch being mounted on said implement at a first position and which must be held closed by an operator for said ignition circuit to actuate said electric starter using one hand of an operator; and
closing a second normally open switch forming part of said ignition circuit, said second normally open switch being mounted on said implement at a second position and which must be held closed by an operator for said ignition circuit to actuate said electric starter, using a different hand of the operator to start the engine.

11. The method as in claim 10, in which said first position is spaced from said second position a sufficient distance to prevent the operator from closing both said first normally open switch and said second normally open switch with a single hand.

12. The method as in claim 10, in which said engine is mounted on a frame having a first rearwardly extending handlebar and a second rearwardly extending handlebar for grasping by a user, and said first normally open switch is mounted proximal said first rearwardly extending handlebar and said second normally open switch is mounted proximal said second rearwardly extending handlebar.

13. The method as in claim 12, including a panel extending between said first rearwardly extending handlebar and said second rearwardly extending handlebar, and said first normally open switch and said second normally open switch are fixed to said panel.

14. The method as in claim 10 including a working device operatively connected to said internal combustion engine.

15. The method as in claim 14, in which said working device is a mower deck.

16. The method as in claim 10, in which said first normally open switch and said second normally open switch are spaced at least five (5) inches apart.

17. The method as in claim 16, in which said first normally open switch and said second normally open switch are spaced at least eight (8) inches apart.

18. The method as in claim 10, in which at least one of said first normally open switch and said second normally open switch is a keyed ignition switch, and the operator inserts a key into said keyed ignition switch prior to closing said keyed ignition switch.

19. The method as in claim 10, in which at least one of said first normally open switch and said second normally open switch is a momentary rocker switch.
